(19) United States
(12) Patent Application Publication
(10) Pub. No.: US 2017/0299917 A1
(43) Pub. Date: Oct. 19, 2017

(54) Display Device Having Improved Transmissivity and Method of Manufacturing the Same

(71) Applicant: Samsung Display Co., Ltd.

(72) Inventors: Yun Jang, Chungcheongnam-do (KR); Kwang-Hyun Kim, Gyeonggi-do (KR); Sangjae Kim, Gyeonggi-do (KR); Seungbeom Park, Gyeonggi-do (KR)

(21) Appl. No.: 15/432,164

(22) Filed: Feb. 14, 2017

(30) Foreign Application Priority Data
Apr. 15, 2016 (KR) 10-2016-0046079

(51) Int. Cl. G02F 1/1335; G02F 1/1333; G02F 1/1341; G02F 1/1337

(52) U.S. Cl. CPC G02F 1/133514; G02F 1/1341; G02F 1/133516; G02F 1/1337; G02F 1/133377; G02F 2001/133738; G02F 2001/133742; G02F 2202/04

(57) ABSTRACT

A display device comprises a first substrate; a color filter layer disposed on the first substrate; a first enclosed microcavity disposed on the color filter layer; an upper liquid crystal layer disposed in the first enclosed microcavity and comprising a dye having a complementary color with respect to a color of the color filter layer; a second substrate facing the first substrate; a second enclosed microcavity disposed on the second substrate; and a lower liquid crystal layer disposed in the second enclosed microcavity and comprising a dye having a complementary color with respect to a color of the color filter layer.

### CROSS-REFERENCE TO RELATED APPLICATIONS

This application claims priority under 35 U.S.C. §119 to Korean Patent Application No. 10-2016-0046079 filed on Apr. 15, 2016 in the Korean Intellectual Property Office (KIPO), the contents of which are herein incorporated by reference in their entireties.

### BACKGROUND

### 1. Field

Exemplary embodiments of the present inventive concept relate generally to display devices. More specifically, exemplary embodiments of the present inventive concept relate to display devices having improved transmissivity and methods of manufacturing the display device.

### 2. Description of the Related Art

Efforts to further develop and refine various display devices, such as a liquid crystal display device (LCD), a plasma display panel (PDP), a field emission display device (FED), and electrophoretic display device (EPD) and an organic light emitting display device (OLED), have been actively conducted.

Some recent efforts have focused on development of a transparent display device.

A liquid crystal display device includes a pair of polarizing plates. A theoretical transmissivity of one polarizing plate may be 50%. However, a real transmissivity of one polarizing plate may be less than 50%. In addition, when more than two polarizing plates are overlapped, this transmissivity drops even further.

### SUMMARY

Exemplary embodiments of the present inventive concept provide a display device having a high transmissivity.

Exemplary embodiments of the present inventive concept also provide a method of manufacturing the display device.

In an exemplary embodiment of a display device according to the present inventive concept, the display device includes a first substrate, a color filter layer disposed on the first substrate, a first enclosed microcavity disposed on the color filter layer and having a cavity, an upper liquid crystal layer disposed in the first enclosed microcavity and comprising a dye having a complementary color with respect to a color of the color filter layer, a second substrate facing the first substrate, a second enclosed microcavity disposed on the second substrate and having a cavity and a lower liquid crystal layer disposed in the second enclosed microcavity and comprising a dye having a complementary color with respect to a color of the color filter layer.

In an exemplary embodiment, the color filter layer may include a first color filter layer comprising a red material, a second color filter layer disposed adjacent to the first color filter layer and comprising a green material and a third color filter layer disposed adjacent to the second color filter layer and comprising a blue material.

In an exemplary embodiment, the upper liquid crystal layer may include a first upper liquid crystal layer disposed on the first color filter layer, a second upper liquid crystal layer disposed on the second color filter layer and a third upper liquid crystal layer disposed on the third color filter layer.

In an exemplary embodiment, a first upper liquid crystal layer may include a dye having a cyan color, the second upper liquid crystal layer may include a dye having a magenta color, and the third upper liquid crystal layer may include a dye having a yellow color.

In an exemplary embodiment, the lower liquid crystal layer may include a first lower liquid crystal layer disposed on the first upper liquid crystal layer, a second lower liquid crystal layer disposed on the second upper liquid crystal layer and a third lower liquid crystal layer disposed on the third upper liquid crystal layer.

In an exemplary embodiment, a first lower liquid crystal layer may include a dye having a cyan color, the second lower liquid crystal layer may include a dye having a magenta color, and the third lower liquid crystal layer may include a dye having a yellow color.

In an exemplary embodiment, a dye of the upper liquid crystal layer may be aligned in a first direction. A dye of the lower liquid crystal layer may be aligned in a second direction crossing the first direction.

In an exemplary embodiment, the upper liquid crystal layer and the lower liquid crystal layer may include a homogeneous alignment type liquid crystal.

In an exemplary embodiment, the upper liquid crystal layer and the lower liquid crystal layer may include a vertical alignment type liquid crystal.

In an exemplary embodiment, the display device may further include a first cover part disposed on the first substrate and a second cover part disposed on the second substrate.

In an exemplary embodiment of a method of manufacturing a display device, the method includes In an exemplary embodiment, forming a color filter layer on a first substrate, forming a first enclosed microcavity on the color filter layer, forming an upper liquid crystal layer in the first enclosed microcavity, the upper liquid crystal layer comprising a dye having a complementary color with respect to a color of the color filter layer, forming a second enclosed microcavity on a second substrate facing the first substrate, and forming a lower liquid crystal layer in the second enclosed microcavity, the lower liquid crystal layer comprising a dye having a complementary color with respect to a color of the color filter layer.

In an exemplary embodiment, the forming a color filter layer may include forming a first color filter layer comprising a red material, forming a second color filter layer comprising a green material and forming a third color filter layer comprising a blue material.

In an exemplary embodiment, the forming an upper liquid crystal layer may include forming a first upper liquid crystal layer on the first color filter layer, forming a second upper liquid crystal layer on the second color filter layer and forming a third upper liquid crystal layer on the third color filter layer.

In an exemplary embodiment, a first upper liquid crystal layer may include a dye having a cyan color, the second upper liquid crystal layer may include a dye having a magenta color, and the third upper liquid crystal layer may include a dye having a yellow color.

In an exemplary embodiment, the forming a lower liquid crystal layer may include forming a first lower liquid crystal layer on an area of the second substrate corresponding to the first upper liquid crystal layer, forming a second lower liquid crystal layer on an area of the second substrate corresponding to the second upper liquid crystal layer and forming a third lower liquid crystal layer on an area of the second substrate corresponding to the third upper liquid crystal layer.

In an exemplary embodiment, a first lower liquid crystal layer may include a dye having a cyan color, the second lower liquid crystal layer may include a dye having a magenta color, and the third lower liquid crystal layer may include a dye having a yellow color.

In an exemplary embodiment, a dye of the upper liquid crystal layer may be aligned in a first direction.

In an exemplary embodiment, a dye of the lower liquid crystal layer may be aligned in a second direction crossing the first direction.

In an exemplary embodiment, the upper liquid crystal layer and the lower liquid crystal layer may include a homogeneous alignment type liquid crystal.

In an exemplary embodiment, the upper liquid crystal layer and the lower liquid crystal layer may include a vertical alignment type liquid crystal.

According to the present exemplary embodiment, a display device may display a black or a white on a display panel without use of a polarizing plate. Thus, a polarizing plate may be eliminated, and thus a display device may have a higher transmissivity.

In addition, the upper and the lower liquid crystal layers include a dye that is one of a cyan, magenta, or yellow dye. Therefore, the upper and the lower liquid crystal layers may be formed at ⅓ the thickness of a liquid crystal layer including all three colored dyes.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a cross-sectional view illustrating a display device according to an exemplary embodiment of the inventive concept;

FIG. 2 is a cross-sectional view illustrating a first substrate of FIG. 1;

FIGS. 3 to 7 are cross-sectional views illustrating a method of manufacturing the upper panel of FIG. 2;

FIG. 8 is a cross-sectional view illustrating an upper panel of FIG. 1;

FIG. 9 is a cross-sectional view illustrating a lower panel of FIG. 1;

FIGS. 10 to 14 are cross-sectional views illustrating a method of manufacturing the lower panel of FIG. 9;

FIG. 15 is a cross-sectional view illustrating a lower panel of FIG. 1;

FIG. 16 is a cross-sectional view illustrating a display device according to an exemplary embodiment of the inventive concept; and

FIG. 17 is a cross-sectional view illustrating a display device according to an exemplary embodiment of the inventive concept.

### DETAILED DESCRIPTION OF THE INVENTIVE CONCEPT

Hereinafter, the present inventive concept will be explained in detail with reference to the accompanying drawings. The various figures are not necessarily to scale. All numerical values are approximate, and may vary. All examples of specific materials and compositions are to be taken as nonlimiting and exemplary only. Other suitable materials and compositions may be used instead.

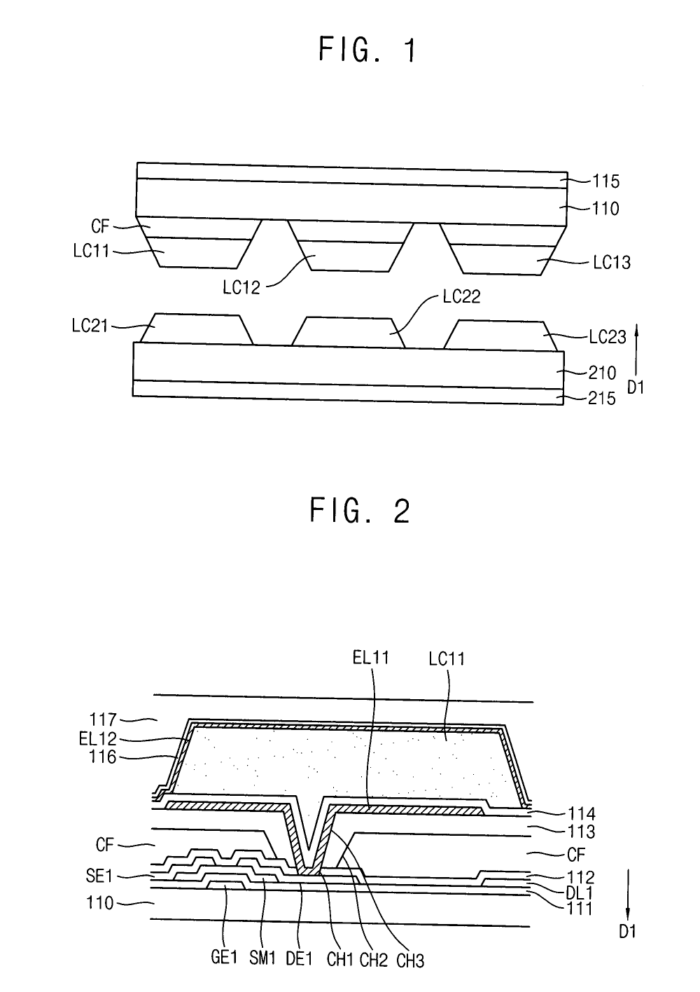

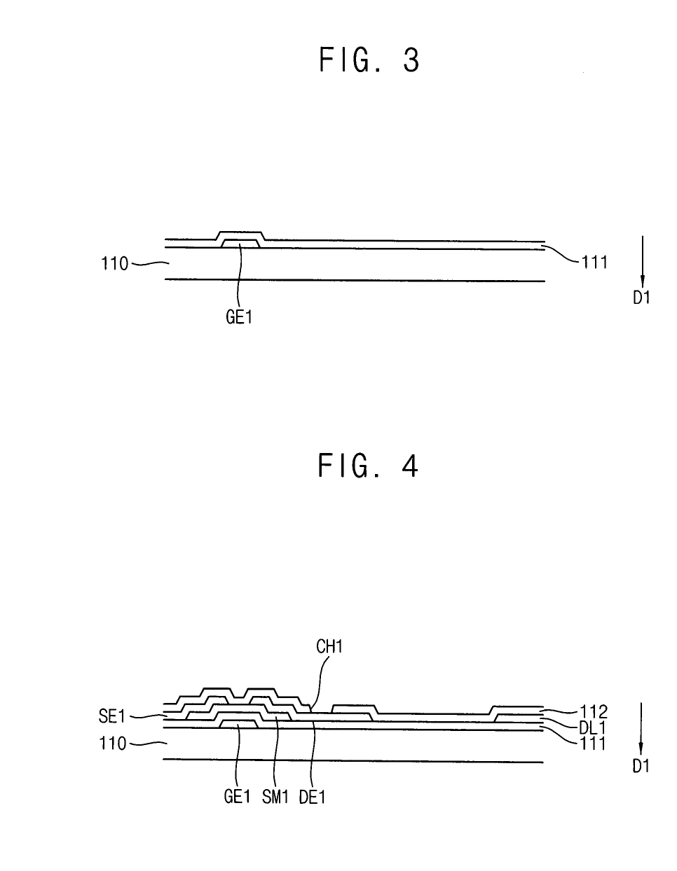

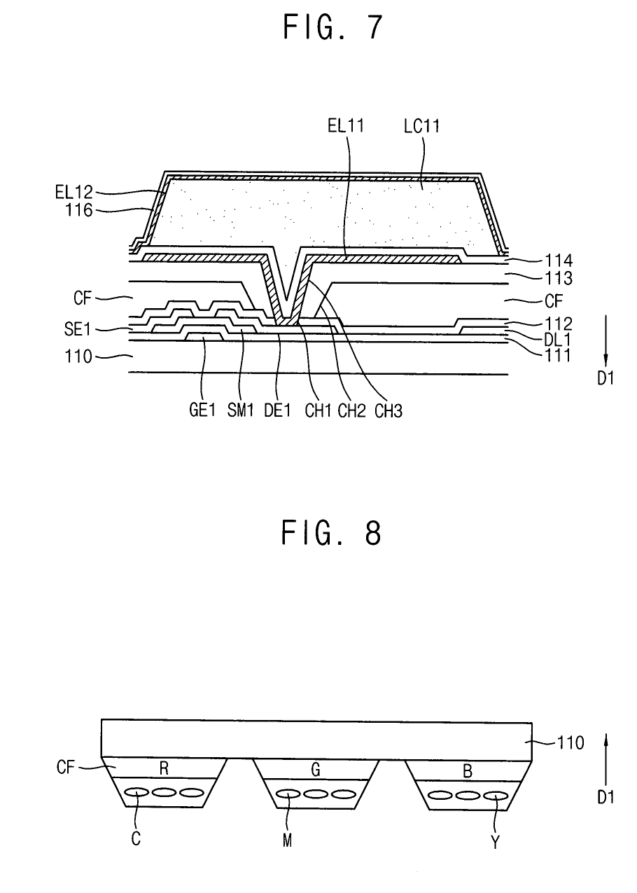

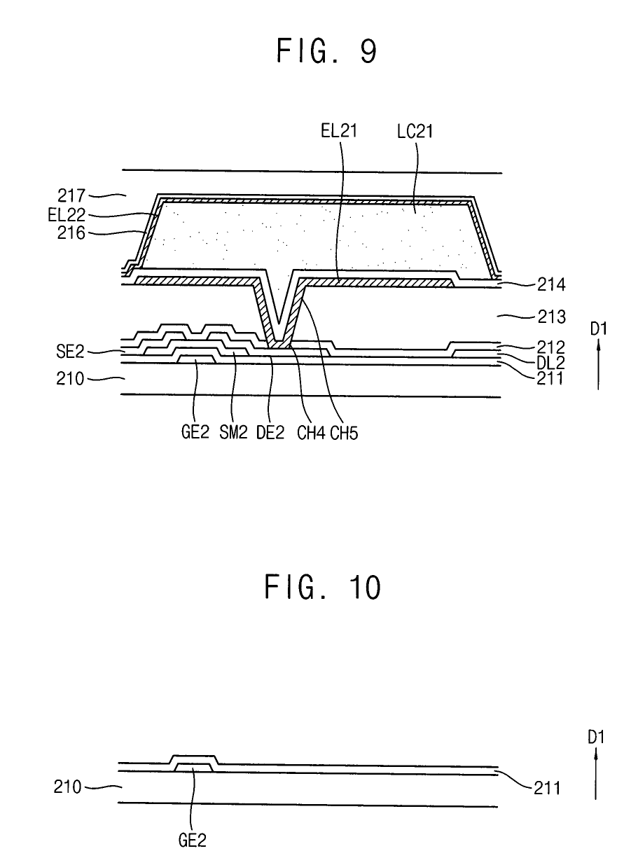

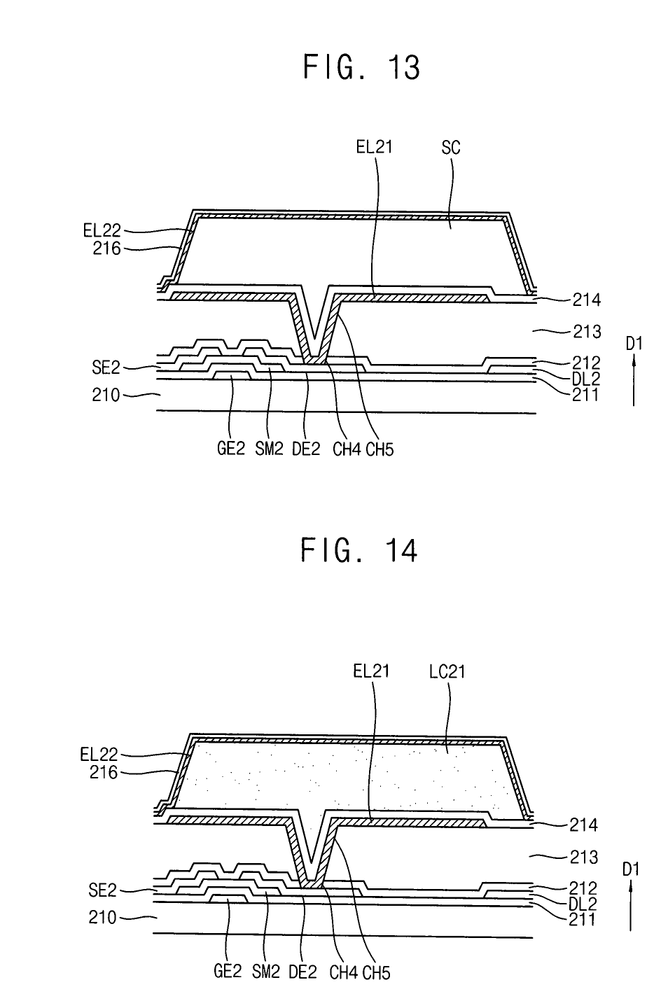

FIG. 1 is a cross-sectional view illustrating a display device according to an exemplary embodiment of the inventive concept. FIG. 2 is a cross-sectional view illustrating a first substrate of FIG. 1. FIG. 8 is a cross-sectional view illustrating an upper panel of FIG. 1. FIG. 9 is a cross-sectional view illustrating a lower panel of FIG. 1. FIG. 15 is a cross-sectional view illustrating a lower panel of FIG. 1.

Referring to FIGS. 1, 2, 8, 9 and 15, a display device according to an exemplary embodiment of the inventive concept includes an upper panel and a lower panel.

The upper panel includes a first substrate 110, a first thin film transistor, a first gate insulating layer 111, a first data insulating layer 112, a color filter CF, a first upper insulating layer 113, a first upper electrode EL11, a second upper insulating layer 114, an upper liquid crystal layer LC11, LC12 and LC13, a second upper electrode EL12, a third upper insulating layer 116, a first cover part 115, a second cover part 215 and a first protecting layer 117. Note that the orientations of FIG. 1 and FIG. 2 are different, as indicated by the differing directions of the arrows representing first direction D1 in each of FIG. 1 and FIG. 2.

The first substrate 110 may be a transparent insulation substrate. For example, the first substrate 110 may be a glass substrate or a transparent plastic substrate. The first substrate 110 has a plurality of pixel areas. Although only one pixel area is described in the figures, the display panel according to example embodiments of the present invention includes a plurality of pixels formed in a plurality of pixel areas. The pixel areas are arrayed in a matrix structure having a plurality of rows and columns The pixel areas each have the same structure, so that only one pixel area will be described herein. Although the pixel area has a rectangular shape in the figures, the pixel area may have various other shapes instead. For example, the pixel area may have a general “V” or “Z” shape.

The first cover part 115 may be disposed on the first substrate 110. The first cover part 115 is disposed on an outer surface of the first substrate 110, and thus the first cover part 115 may protect the first substrate 110 from external shock.

The first cover part 115 may be formed by an anti reflection coating process or a hard coating process. The first cover part 115 may thus act to protect the first substrate 110 from external shock.

In addition, the first cover part 115 may perform an anti-reflection, an anti-static, an anti-pollution and/or an abrasion-resistance function.

For example, the first cover part 115 may be disposed on the first substrate 110 as a film.

A first gate electrode GE1 of the thin film transistor is disposed on the first substrate 110, and connected to a first gate line (not shown).

The first gate insulating layer 111 is disposed on the first gate line and the first gate electrode GE1 of the first thin film transistor.

A first semiconductor pattern SM1 of the thin film transistor is disposed on the first gate insulating layer 111 and overlaps the first gate electrode GE1.

A first source electrode SE1 is disposed on the first semiconductor pattern SM1, and connected to the first data line DL1.

The first drain electrode DE1 of the thin film transistor is disposed on the first semiconductor pattern SM1 and the first gate insulating layer 111.

The first thin film transistor includes the first gate electrode GE1, the first source electrode SE1, the first drain electrode DE1 and the first semiconductor pattern SM1. The first thin film transistor, the first gate line and the first data line DL1 may include a metal oxide which has relatively low surface reflectance. For example, the first thin film transistor, the first gate line and the first data line DL1 may include chromium oxide (Cr-oxide). Thus, although a user located in the first direction D1 with respect to the first substrate 110 sees the first substrate 110, the user cannot recognize patterns of the thin film transistor, the gate line and the first data line DL1.

The first drain electrode DE1 is disposed on the first semiconductor pattern SM1, and spaced apart from the first source electrode SE1. The first semiconductor pattern SM1 forms a conductive channel between the first source electrode SE1 and the first drain electrode DE1.

The first data insulating layer 112 is disposed on the first thin film transistor and the first data line DL. A first contact hole CH1 is formed through the first data insulating layer 112. The first contact hole CH1 overlaps a portion of the first drain electrode DE1. Thus, the first contact hole CH1 exposes a portion of the first drain electrode DE1.

The color filter CF is disposed on the first data insulating layer 112. A second contact hole CH2 is formed through the color filter CF. The second contact hole CH2 overlaps a portion of the first drain electrode DE1 and the first contact hole CH1.

The color filter CF supplies colors to light passing through the image displaying layer LC. The color filter CF may include a red color filter, a green color filter and a blue color filter. The color filter CF corresponds to a pixel area. Adjacent color filters may have different colors. In addition, the color filter CF may overlap an adjacent color filter CF in a boundary of the pixel area.

The first upper insulating layer 113 is disposed on the color filter CF. A third contact hole CH3 is formed through the first upper insulating layer 113. The third contact hole CH3 overlaps the portion of the first drain electrode DE1, the first contact hole CH1 and the second contact hole CH2.

The first upper electrode EL11 is disposed on the first upper insulating layer 113. The first upper electrode EL11 is connected to the first drain electrode DE1 through the first to third contact holes CH1, CH2 and CH3. The first upper electrode EL11 covers almost all of the pixel area. The first upper electrode EL11 may have an approximately rectangular shape, or a shape having a plurality of stems and a plurality of branches protruded from the stems.

The second upper insulating layer 114 is disposed on the first upper electrode EL11.

The upper liquid crystal layers LC11, LC12 and LC13 are disposed on the second upper insulating layer 114. The upper liquid crystal layers LC11, LC12 and LC13 may each include a liquid crystal.

The upper liquid crystal layers LC11, LC12 and LC13 may include a dye including cyan color, a dye including magenta color or a dye including yellow color. Any other colors are also contemplated.

As illustrated in FIG. 8, the color filter CF may include a red color filter R, a green color filter G and a blue color filter B. The upper liquid crystal layer disposed on the color filter CF may include a dye including cyan color, a dye including magenta color or a dye including yellow color respectively.

The upper liquid crystal layer may be formed as a guest-host liquid crystal including a dye including cyan color, a dye including magenta color or a dye including yellow color respectively. The upper liquid crystal layer is disposed on the color filter CF and disposed in the cavity of the first capsular structure.

The cyan-colored upper liquid crystal layer may be disposed on the red color filter R. A cyan color may be a complementary color with respect to a red color. Thus, the cyan-colored liquid crystal layer may absorb a red light.

The magenta-colored upper liquid crystal layer may be disposed on the green color filter G A magenta color may be a complementary color with respect to a green color. Thus, the magenta-colored liquid crystal layer may absorb a green light.

The yellow-colored upper liquid crystal layer may be disposed on the blue color filter B. A yellow color may be a complementary color with respect to a blue color. Thus, the yellow-colored liquid crystal layer may absorb a blue light.

In general, a guest-host type liquid crystal display device includes a dye including cyan color, a dye including magenta color or a dye including yellow color, and thus the guest-host type liquid crystal display device may form a black color by mixing the cyan color, magenta color and yellow color.

However, a display device according to an exemplary embodiment of the inventive concept includes upper liquid crystal layers including a dye including cyan color, a dye including magenta color and a dye including yellow color respectively. The upper liquid crystal layers are disposed on the red color filter R, the green color filter G and the blue color filter B respectively. Thus, the upper liquid crystal layer includes a cyan-, magenta- or yellow-colored dye. Therefore, the upper liquid crystal layer may be formed at approximately ⅓ of the thickness of a conventional liquid crystal layer that includes each of the dye including cyan color, the dye including magenta color and the dye including yellow color.

An alignment layer (not shown) may be disposed between the second upper insulating layer 114 and the upper liquid crystal layer LC11, LC12 and LC13. The alignment layer pre-tilts the liquid crystal of the upper liquid crystal layer LC11, LC12 and LC13. However, the alignment layer may be eliminated according to a type of the upper liquid crystal layer LC11, LC12 and LC13 or a structure of the first and second upper electrodes EL11 and EL12. For example, when the first upper electrode EL11 has micro slits, so that the upper liquid crystal layer LC11, LC12 and LC13 may be aligned without an additional alignment layer, then the alignment layer may be eliminated. In addition, when the display panel includes a reactive-mesogen layer for initial alignment of the upper liquid crystal layer LC11, LC12 and LC13, then the alignment layer may be eliminated.

The second upper electrode EL12 is disposed on the upper liquid crystal layer LC11, LC12 and LC13. The second upper electrode EL12 and the first upper electrode EL11 form an electric field between the first upper electrode EL11 and the second upper electrode EL12. A portion of the second upper electrode EL12 is spaced apart from the second upper insulating layer 114, so that a tunnel-shaped cavity, or microcavity, is formed between the second upper insulating layer 114 and the second upper electrode EL12. The upper liquid crystal layer LC11, LC12 and LC13 is disposed in the tunnel-shaped cavity.

The upper liquid crystal layer LC11, LC12 and LC13 may include liquid crystal molecules having optical anisotropy. The liquid crystal molecules are driven by an electric field, so that an image is displayed by selectively passing or blocking light through the upper liquid crystal layer LC11, LC12 and LC13.

The third upper insulating layer 116 is disposed on the second upper electrodes EL12.

The first protecting layer 117 is disposed on the third upper insulating layer 116. The first protecting layer 117 includes a semi-hardening macromolecule material. The macromolecule material may have liquidity before hardening. The semi-hardening macromolecule material is formed in a flat shape, then the flat shaped semi-hardening macromolecule material is disposed on the display panel and pressed to form the first protecting layer 117. The semi-hardening macromolecule material may be pressed into a recessed portion of the display panel due to its liquidity.

The lower panel includes a second substrate 210, a second thin film transistor, a second gate insulating layer 211, a second data insulating layer 212, a first lower insulating layer 213, a first lower electrode EL21, a second lower insulating layer 214, a lower liquid crystal layer LC21, LC22 and LC23, a second lower electrode EL22, a third lower insulating layer 216, and a second protecting layer 217.

The second substrate 110 may be a transparent insulation substrate. For example, the second substrate 110 may be a glass substrate or a transparent plastic substrate. The second substrate 110 has a plurality of pixel areas. Although only one pixel area is described in the figures, the display panel according to example embodiments of the present invention include a plurality of pixels formed in a plurality of pixel areas. The pixel areas are arrayed in a matrix structure having a plurality of rows and columns. The pixel areas each have the same structure, so that only one pixel area will be described herein. Although the pixel area has a rectangular shape in the figures, the pixel area may have various other shapes instead. For example, the pixel area may have a general “V” or “Z” shape.

The second cover part 215 may be disposed on the second substrate 210. The second cover part 215 is disposed on an external or outer surface of the second substrate 210, and thus the second cover part 215 may protect the second substrate 210 from external shock.

The second cover part 215 may be formed by an anti reflection coating process or a hard coating process. The second cover part 215 may thus protect the second substrate 210 from external shock.

In addition, the second cover part 215 may perform an anti-reflection, an anti-static, an anti-pollution and/or an abrasion-resistance function.

For example, the second cover part 215 may be disposed on the second substrate 210 as a film.

A second gate electrode GE2 of the thin film transistor is disposed on the second substrate 210, and connected to a second gate line (not shown).

The second gate insulating layer 211 is disposed on the second gate line and the second gate electrode GE2 of the second thin film transistor.

A second source electrode SE2 is disposed on the second semiconductor pattern SM2, and connected to the second data line DL2.

The second drain electrode DE2 of the second thin film transistor is disposed on the second semiconductor pattern SM2 and the second gate insulating layer 211.

The second thin film transistor includes the second gate electrode GE2, the second source electrode SE2, the second drain electrode DE2 and the second semiconductor pattern SM2. The second thin film transistor, the second gate line and the second data line DL2 may include a metal oxide which has relatively low surface reflectance. For example, the second thin film transistor, the second gate line and the second data line DL2 may include chromium oxide (Cr-oxide). Thus, although a user located in the first direction D1 with respect to the second substrate 210 sees the second substrate 210, the user cannot recognize patterns of the thin film transistor, the second gate line and the second data line DL2.

The second drain electrode DE2 is disposed on the second semiconductor pattern SM2, and spaced apart from the second source electrode SE2. The second semiconductor pattern SM2 forms a conductive channel between the second source electrode SE2 and the second drain electrode DE2.

The second data insulating layer 212 is disposed on the second thin film transistor and the second data line DL2. A fourth contact hole CH4 is formed through the second data insulating layer 212. The fourth contact hole CH4 overlaps a portion of the second drain electrode DE2. Thus, the fourth contact hole CH4 exposes a portion of the second drain electrode DE2.

The first lower insulating layer 213 is disposed on the second data insulating layer 212. A fifth contact hole CH5 is formed through the first lower insulating layer 213. The fifth contact hole CH5 overlaps the portion of the second drain electrode DE2, and the fourth contact hole CH4.

The first lower electrode EL21 is disposed on the first lower insulating layer 213. The first lower electrode EL21 is connected to the second drain electrode DE2 through the fourth and fifth contact holes CH4 and CH5. The first lower electrode EL21 covers almost the entirety of the pixel area. The first lower electrode EL21 may have an approximately rectangular shape, or a shape having a plurality of stems and a plurality of branches protruded from the stems.

The second lower insulating layer 214 is disposed on the first lower electrode EL21.

The lower liquid crystal layers LC21, LC22 and LC23 are disposed on the second lower insulating layer 214. The lower liquid crystal layers LC21, LC22 and LC23 may be liquid crystal layer having a liquid crystal.

The lower liquid crystal layers LC21, LC22 and LC23 may include a dye including cyan color, a dye including magenta color or a dye including yellow color.

As illustrated in FIG. 15, the lower liquid crystal layers LC21, LC22 and LC23 may include a dye including cyan color, a dye including magenta color and a dye including yellow color respectively.

The lower liquid crystal layer may be formed as a guest-host liquid crystal including a dye including cyan color, a dye including magenta color or a dye including yellow color. The lower liquid crystal layer is disposed on upper liquid crystal layer and disposed in the cavity formed by the first capsular structure.

The first lower liquid crystal layer LC21 includes a dye including cyan color and is disposed on an area corresponding to the first upper liquid crystal layer LC11. A cyan color may be a complementary color with respect to a red color. Thus, the dye including cyan color may absorb a red light.

The second lower liquid crystal layer LC22 includes a dye including magenta color and is disposed on an area corresponding to the second upper liquid crystal layer LC12. A magenta color may be a complementary color with respect to a green color. Thus, the dye including magenta color may absorb a green light.

The third lower liquid crystal layer LC23 includes a dye including yellow color and is disposed on an area corresponding to the third upper liquid crystal layer LC13. A yellow color may be a complementary color with respect to a blue color. Thus, the dye including yellow color may absorb a blue light.

In general, a guest-host type liquid crystal display device includes a dye including cyan color, a dye including magenta color or a dye including yellow color, and thus the guest-host type liquid crystal display device may form a black color by mixing the cyan color, magenta color and yellow color.

However, a display device according to an exemplary embodiment of the inventive concept includes upper liquid crystal layers including a dye including cyan color, a dye including magenta color and a dye including yellow color respectively. The lower liquid crystal layers LC21, LC22 and LC23 are disposed on areas corresponding to the first upper liquid crystal layer LC11, the second upper liquid crystal layer LC12 and the third upper liquid crystal layer LC13 respectively. Thus, the lower liquid crystal layer includes each of the dye including cyan color, the dye including magenta color and the dye including yellow color. Therefore, the lower liquid crystal layer may be formed at ⅓ of the thickness of a conventional liquid crystal layer including all of these dyes.

The second lower electrode EL22 is disposed on each of the lower liquid crystal layer LC21, LC22 and LC23.

An alignment layer (not shown) may be disposed between the second lower insulating layer 214 and the lower liquid crystal layer LC21, LC22 and LC23. The alignment layer pre-tilts the liquid crystal of the lower liquid crystal layer LC21, LC22 and LC23 and LC13. However, the alignment layer may be eliminated according to a type of the lower liquid crystal layer LC21, LC22 and LC23 or a structure of the first and second lower electrodes EL21 and EL22. For example, when the first lower electrode EL21 has micro slits, so that the lower liquid crystal layer LC21, LC22 and LC23 may be aligned without an additional alignment layer, then the alignment layer may be eliminated. In addition, when the display panel includes a reactive-mesogen layer for initial alignment of the lower liquid crystal layer LC21, LC22 and LC23, then the alignment layer may be eliminated.

The second lower electrode EL22 is disposed on the lower liquid crystal layer LC21, LC22 and LC23. The second lower electrode EL22 and the first lower electrode EL21 form an electric field between the first lower electrode EL21 and the second lower electrode EL22. A portion of the second lower electrode EL22 is spaced apart from the second lower insulating layer 214, so that a tunnel-shaped cavity is formed between the second lower insulating layer 214 and the second lower electrode EL22. The lower liquid crystal layer LC21, LC22 and LC23 is disposed in each tunnel-shaped cavity.

The third lower insulating layer 216 is disposed on the second lower electrode EL22.

The second protecting layer 217 is disposed on the third lower insulating layer 216. The second protecting layer 217 includes a semi-hardening macromolecule material. The macromolecule material may have liquidity before hardening. The semi-hardening macromolecule material is formed in a flat shape, then the flat shaped semi-hardening macromolecule material is disposed on the display panel and pressed to form the second protecting layer 217. The semi-hardening macromolecule material may be pressed into a recessed portion of the display panel due to its liquidity.

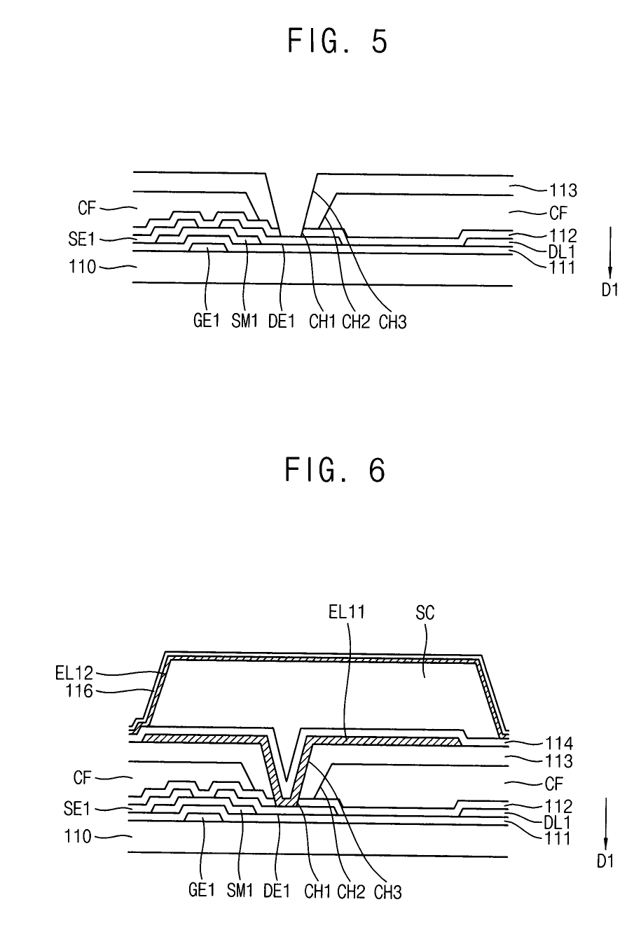

FIGS. 3 to 7 are cross-sectional views illustrating a method of manufacturing the upper panel of FIG. 2.

Referring to FIG. 3, a first gate electrode GE1 and a first gate line are formed on a first substrate 110. More specifically, a conductive layer is formed and patterned into the first gate electrode GE1 and the first gate line by photolithography.

The method may further include oxidizing the conductive layer after patterning the conductive layer. Accordingly, the first gate electrode GE1 and the first gate line may include chromium oxide (Cr-oxide).

A first gate insulating layer 111 is formed on the first substrate 110 over the first gate electrode GE1 and the first gate line. The first gate insulating layer 111 thus covers and insulates the first gate electrode GE1 and the first gate line.

Referring to FIG. 4, a first semiconductor pattern SM1 is formed on the first gate insulating layer 111. A first data line DL1, a first source electrode SE1 and a first drain electrode DE1 are formed on the first gate insulating layer 111 on which the first semiconductor pattern SM1 is formed. The first semiconductor pattern SM1, the first gate electrode GE1, the first source electrode SE1 and the first drain electrode DE1 make up a first thin film transistor.

The method may further include oxidizing the first data line DL, the first source electrode SE1 and the first drain electrode DE1 after forming the first data line DL1, the first source electrode SE1 and the first drain electrode DE1. Thus, the first data line DL1, the first source electrode SE1 and the first drain electrode DE1 may include chromium oxide (Cr-oxide).

A first data insulating layer 112 is formed on the first gate insulating layer 111 on which the first semiconductor pattern SM1, the first data line DL1, the first source electrode SE1 and the first drain electrode DE1 are formed. The first data insulating layer 112 covers and insulates the first thin film transistor and the first data line DL1.

A first contact hole CH1 is formed through the first data insulating layer 112. The first contact hole CH1 exposes a portion of the first drain electrode DE1.

Referring to FIG. 5, a color filter CF is formed on the first data insulating layer 112. A second contact hole CH2 is formed through the color filter CF, and overlaps the portion of the first drain electrode DE1 exposed by the first contact hole CH1.

The color filter CF may include a red color filter, a green color filter and blue color filter. The color filter CF includes an organic macromolecule material. The color filter CF may be formed using photonastic macromolecule material via photolithography. The color filter CF may be formed via an inkjet process or the like.

A first upper insulating layer 113 is formed on the color filter CF. A third contact hole CH3 is formed through the first upper insulating layer 113, and overlaps the exposed portion of the first drain electrode DE1, the first contact hole CH1 and the second contact hole CH2.

Referring to FIG. 6, a first upper electrode EL11 is formed on the first upper insulating layer 113. The first upper electrode EL11 may include a transparent conductive material, such as indium tin oxide (ITO), indium zinc oxide (IZO) and the like. The first upper electrode EL11 is electrically connected to the first drain electrode DE1 through the first to third contact holes CH1, CH2 and CH3.

A second upper insulating layer 114 is formed on the first upper insulating layer 113 and over the first upper electrode EL11. The second upper insulating layer 114 covers and insulates the first upper electrode EL11. The second upper insulating layer 114 includes an inorganic insulating material, such as silicon nitride (SiNx), silicon oxide (SiOx) and the like.

A sacrificial layer SC is formed on the second upper insulating layer 114. The sacrificial layer SC corresponds to the pixel area. The sacrificial layer SC may include an organic macromolecule material such as an organic material including benzocyclobutene (BCB) and acryl resin. The sacrificial layer SC may be formed via evaporation and ashing processes or evaporation and polishing processes. In addition, the sacrificial layer SC may be formed via inkjet process or spin coating process, but is not limited thereto.

The sacrificial layer SC will be removed later to form a tunnel-shaped cavity, so that the sacrifice layer SCR has dimensions substantially the same as those of the tunnel-shaped cavity.

A second upper electrode EL12 is formed on second upper insulating layer 114 and over the sacrificial layer SC. The second upper electrode EL12 may include a transparent conductive material, such as indium tin oxide (ITO), indium zinc oxide (IZO) and the like. A transparent conductive layer is formed, and is then patterned into the second upper electrode EL12 via a process such as photolithography.

A third insulating layer 116 is formed on the second upper electrode EL12.

Referring to FIG. 7, the tunnel-shaped cavity is formed by selectively removing the sacrificial layer SC, for example via a plasma process. The sacrificial layer SC is at least partially etched into via an anisotropic plasma etching process. Thereafter, a selective and anisotropic removal process is applied for selectively removing the material of the sacrificial layer SC while essentially not removing the surrounding other materials. Accordingly, the second upper electrode EL12 and an upper surface of the third upper insulating layer 116 are exposed by way of the selective and anisotropic removal process. The under surface of the second upper electrode EL12 and the upper surface of the second upper insulating layer 114 are inner surfaces of the tunnel-shaped cavity.

The plasma process is for anisotropically removing organic layer, and may be a process such as a microwave O2 plasma process, but is not limited thereto. Stage temperature, chamber pressure, and use gas of the microwave O2 plasma may be adjusted to etch only organic insulating material. Accordingly, the second upper insulation layer 114, including inorganic insulating material, is not etched. In the microwave O2 plasma etching process, the stage temperature of an etching chamber may be about 100-300° C., an amount of O2 flow may be about 5000-10000 sccm, an amount of diazene (N2H2) flow may be about 100-1000 sccm, and a pressure of the etching chamber may be about 2 Torr, while applied power may be about 100-4000 W.

An alignment layer is then formed in the tunnel-shaped cavity. Thus, the alignment layer is formed on the upper surface of the second upper insulation layer 114 and an under (or lower) surface of the second upper electrode EL12. The alignment layer is formed using an alignment solution. The alignment solution may include a mixture of alignment material, such as polyamide, and proper solvent such as polyamide. The alignment solution is supplied as a liquid, so that the alignment solution moves into the tunnel-shaped cavity due to capillary phenomenon. The alignment solution is supplied using inkjets with micro pipettes, or using vacuum injection equipment. After that, the solvent is removed. The first substrate 110 may be kept at a room temperature or heated to remove the solvent.

The alignment layer may be eliminated according to type of the liquid crystal layer, or shapes of the first and second upper electrodes EL11 and EL12. For example, if the first and second upper electrodes EL11 and EL12 have a specific pattern, then the alignment layer may be eliminated.

An upper liquid crystal layer LC11 including liquid crystal molecules is formed in the tunnel-shaped cavity in which the alignment layer is formed. The liquid crystal molecules are supplied as a liquid, so that the liquid crystal molecules move into the tunnel-shaped cavity due to capillary phenomenon. The upper liquid crystal layer LC11 may be supplied using an inkjet with a micro pipette, or using vacuum injection equipment. Using the vacuum injection equipment, the hole is immersed into a container receiving the liquid crystal molecules, and then pressure of a chamber in which the container is disposed is decreased, so that the liquid crystal molecules move into the tunnel-shaped cavity due to capillary phenomenon.

A first protecting layer 117 may then be formed on the third upper insulating layer 116.

The first protecting layer 117 includes a semi-hardening macromolecule material. The macromolecule material may have liquidity, i.e. may be in a liquid state, before hardening. The semi-hardening macromolecule material is formed having a flat shape, then the flat shaped semi-hardening macromolecule material is disposed on the display panel and pressed to form the first protecting layer 117. The semi-hardening macromolecule material may be pressed into a recessed portion of the display panel due to its liquidity.

The insulating layer of the present example embodiments may be eliminated. For example, if the first upper electrode EL11 and the second upper electrodes EL12 include specific material which may be protected from the plasma process removing the sacrificial layer SC, then the first to third upper insulating layers 113, 114 and 116 may be eliminated.

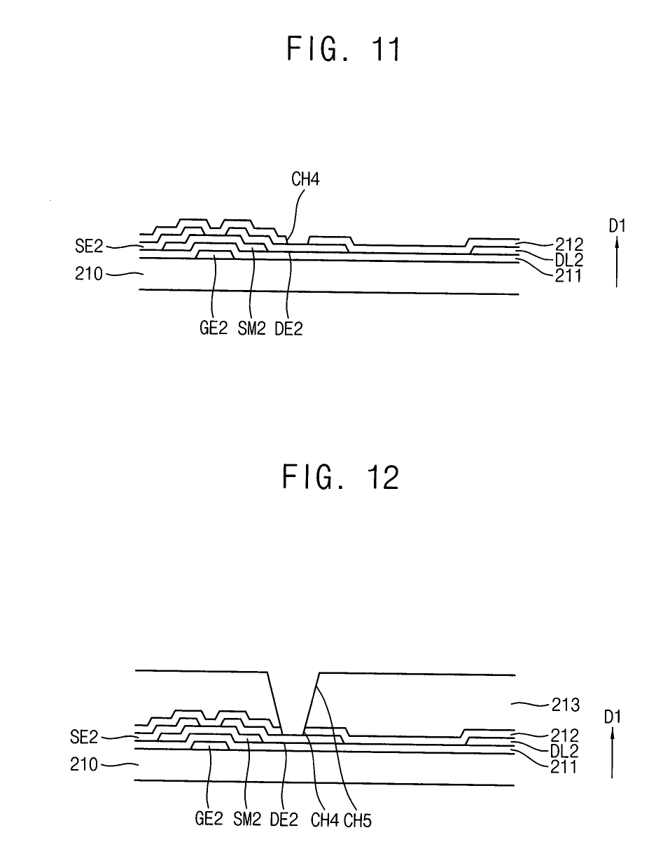

FIGS. 10 to 14 are cross-sectional views illustrating a method of manufacturing the lower panel of FIG. 9.

Referring to FIG. 10, a second gate electrode GE2 and a second gate line are formed on a second substrate 210. More specifically, a conductive layer is formed, and subsequently patterned into the second gate electrode GE2 and the second gate line by photolithography.

The method may further include oxidizing the conductive layer after patterning the conductive layer. Accordingly, the second gate electrode and the second gate line may include chromium oxide (Cr-oxide).

A second gate insulating layer 211 is formed on the second substrate 210 after the second gate electrode GE2 and the second gate line are formed. The second gate insulating layer 211 covers and insulates the second gate electrode GE2 and the second gate line.

Referring to FIG. 11, a second semiconductor pattern SM2 is formed on the second gate insulating layer 211. A second data line DL2, a second source electrode SE2 and a second drain electrode DE2 are formed on the second gate insulating layer 211 on which the second semiconductor pattern SM2 is formed. The second semiconductor pattern SM2, the second gate electrode GE2, the second source electrode SE2 and the second drain electrode DE2 collectively make up a second thin film transistor.

The method may further include oxidizing the second data line DL2, the second source electrode SE2 and the second drain electrode DE2 after forming the second data line DL2, the second source electrode SE2 and the second drain electrode DE2. Thus, the second data line DL2, the second source electrode SE2 and the second drain electrode DE2 may include chromium oxide (Cr-oxide).

A second data insulating layer 212 is formed on the second gate insulating layer 211 after the second semiconductor pattern SM2, the second data line DL2, the second source electrode SE2 and the second drain electrode DE2 are formed. The second data insulating layer 212 covers and insulates the second thin film transistor and the second data line DL2.

A fourth contact hole CH4 is formed through the second data insulating layer 212. The fourth contact hole CH4 exposes a portion of the second drain electrode DE2.

Referring to FIG. 12, a first upper insulating layer 213 is formed on the second data insulating layer 212.

A fifth contact hole CH5 is formed through the first upper insulating layer 213, and overlaps the portion of the second drain electrode DE2 exposed by the fourth contact hole CH4.

Referring to FIG. 13, a first lower electrode EL21 is formed on the first upper insulating layer 213. The first lower electrode EL21 may include a transparent conductive material, such as indium tin oxide (ITO), indium zinc oxide (IZO) and the like. The first lower electrode EL21 is electrically connected to the second drain electrode DE2 through the fourth and fifth contact holes CH4 and CH5.

A second lower insulating layer 214 is formed on the first lower insulating layer 213 over the first lower electrode EL21. The second lower insulating layer 214 covers and insulates the first lower electrode EL21. The second lower insulating layer 214 includes an inorganic insulating material, such as silicon nitride (SiNx), silicon oxide (SiOx) and the like.

A sacrificial layer SC is formed on the second lower insulating layer 214. The sacrificial layer SC corresponds to the pixel area. The sacrificial layer SC may include an organic macromolecule material such as an organic material including benzocyclobutene (BCB) and acryl resin. The sacrificial layer SC may be formed via evaporation and ashing processes or evaporation and polishing processes. In addition, the sacrificial layer SC may be formed via inkjet process or spin coating process, but is not limited thereto.

The sacrificial layer SC will be removed later to form a tunnel-shaped cavity, so that the sacrificial layer SC has dimensions substantially the same as those of the tunnel-shaped cavity.

A second lower electrode EL22 is formed on the second lower insulating layer 214 over the sacrificial layer SC. The second lower electrode EL22 may include a transparent conductive material, such as indium tin oxide (ITO), indium zinc oxide (IZO) and the like. More particularly, a transparent conductive layer is formed, and the transparent conductive layer is patterned into the second lower electrode EL22 via photolithography.

A third lower insulating layer 216 is subsequently formed on the second lower electrode EL22.

Referring to FIG. 14, the tunnel-shaped cavity is formed by selectively removing the sacrificial layer SC, for example via a plasma process. The sacrificial layer SC is at least partially etched into via an anisotropic plasma etching process. Thereafter, a selective and anisotropic removal process is applied for selectively removing the material of the sacrificial layer SC while essentially not removing the surrounding other materials. Accordingly, the second lower electrode EL22 and an upper surface of the third lower insulating layer 216 are exposed by way of the selective and anisotropic removal process. The under surface of the second lower electrode EL22 and the upper surface of the second lower insulating layer 214 thus become inner surfaces of the tunnel-shaped cavity.

The plasma process is for anisotropically removing organic layers, and may employ plasmas such as microwave O2 plasma, but is not limited thereto. Stage temperature, chamber pressure, and use gas of the microwave O2 plasma may be adjusted to etch only organic insulating material. Accordingly, the second lower insulation layer 214, including inorganic insulating material, is not etched. In the microwave O2 plasma etching process, the stage temperature of an etching chamber may be about 100-300° C., an amount of O2 flow may be about 5000-10000 sccm, an amount of diazene (N2H2) flow may be about 100-1000 sccm, a pressure of the etching chamber may be about 2 Torr, and applied power may be about 100-4000 W.

An alignment layer is formed in the tunnel-shaped cavity. Thus, the alignment layer is formed on the upper surface of the second lower insulation layer 214 and an under surface of the second lower electrode EL22, i.e. on the walls defining the cavity. The alignment layer is formed using an alignment solution. The alignment solution may include a mixture of alignment material, such as polyamide, and proper solvent such as polyamide. The alignment solution is supplied as a liquid, so that the alignment solution moves into the tunnel-shaped cavity due to capillary phenomenon. The alignment solution is supplied using an inkjet with a micro pipette, or using vacuum injection equipment. After that, the solvent is removed. The second substrate 210 may be kept at room temperature or heated to remove the solvent.

The alignment layer may be eliminated according to type of the liquid crystal layer, or shapes of the first and second lower electrodes EL21 and EL22. For example, if the first and second lower electrodes EL21 and EL22 have a specific pattern, then the alignment layer may be eliminated.

A second protecting layer 217 may be formed on the third lower insulating layer 216.

The second protecting layer 217 includes a semi-hardening macromolecule material. The macromolecule material may have liquidity before hardening. The semi-hardening macromolecule material is formed having a flat shape, then the flat shaped semi-hardening macromolecule material is disposed on the display panel and pressed to form the second protecting layer 217. The semi-hardening macromolecule material may be pressed into the recessed portions of the display panel due to its liquidity.

The insulating layer of the present example embodiments may be eliminated. For example, if the first lower electrode EL21 and the second lower electrode EL22 include specific material which is not removed by the plasma process that removes the sacrificial layer SC, then the first to third lower insulating layers 213, 214 and 216 may be eliminated.

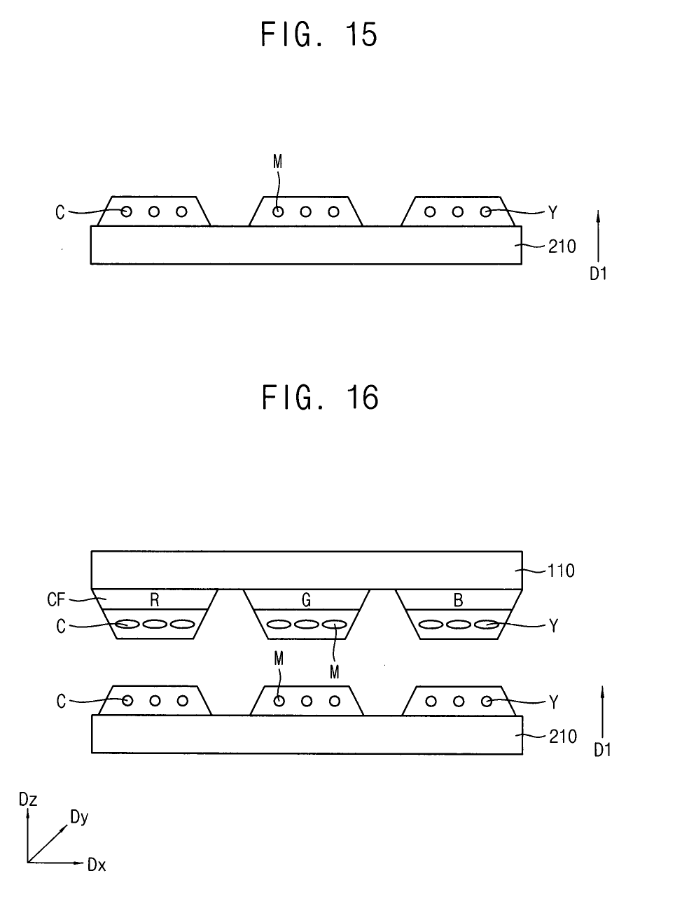

FIG. 16 is a cross-sectional view illustrating a display device according to an exemplary embodiment of the inventive concept.

Referring to FIG. 16, a display device according to an exemplary embodiment of the inventive concept displays a black on a display panel.

The upper liquid crystal layer may be formed as a guest-host liquid crystal including a cyan, magenta or yellow dye. The upper liquid crystal layer is disposed on the color filter CF and disposed in the first enclosed microcavities. The lower liquid crystal layer may be formed as a guest-host liquid crystal including a cyan, magenta or yellow dye. The lower liquid crystal layer is disposed on the upper liquid crystal layer and disposed in the first microcavities. In addition, the upper liquid crystal layer overlaps the lower liquid crystal layer.

A cyan, magenta or yellow dye in the upper liquid crystal layer is aligned in an x-direction Dx, and a cyan, magenta or yellow dye in the lower liquid crystal layer is aligned in a y-direction Dy crossing the x-direction Dx.

When a voltage is not applied to a homogeneous alignment type liquid crystal layer, a cyan, magenta or yellow dye included in the upper liquid crystal layer is aligned in a x-direction Dx, and a cyan, magenta or yellow dye included in the lower liquid crystal layer is aligned in a y-direction Dy. In addition, when a voltage is applied to a vertical alignment type liquid crystal layer, a cyan, magenta or yellow dye included in the upper liquid crystal layer is aligned in a x-direction Dx, and a cyan, magenta or yellow dye included in the lower liquid crystal layer is aligned in a y-direction Dy.

The cyan-colored upper liquid crystal layer is disposed on the red color filter R. A cyan color may be a complementary color with respect to a red color. Thus, the dye including cyan color may absorb a red light.

The magenta-colored upper liquid crystal layer is disposed on the green color filter G. A magenta color may be a complementary color with respect to a green color. Thus, the dye including magenta color may absorb a green light.

The yellow-colored upper liquid crystal layer is disposed on the blue color filter B. A yellow color may be a complementary color with respect to a blue color. Thus, the dye including yellow color may absorb a blue light.

Thus, when a cyan, magenta or yellow dye included in the upper and the lower liquid crystal layer are aligned in a horizontal direction, a light may be polarized. Therefore, a display device may display a black on a display panel. Accordingly, a display device may polarize light without a polarizing plate, and thus a polarizing plate may be eliminated.

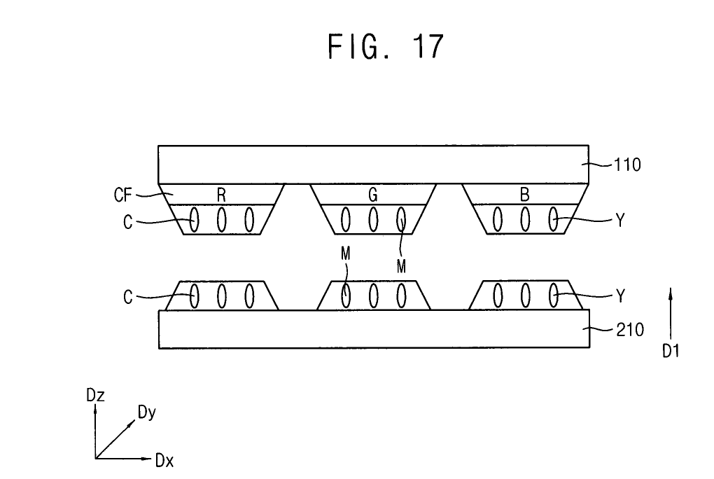

FIG. 17 is a cross-sectional view illustrating a display device according to an exemplary embodiment of the inventive concept.

Referring to FIG. 17, a display device according to an exemplary embodiment of the inventive concept displays a white on a display panel.

The upper liquid crystal layer may be formed as a guest-host liquid crystal including a cyan, magenta or yellow dye. The upper liquid crystal layer is disposed on the color filter CF and disposed in the first capsular structure having a cavity. The lower liquid crystal layer may be formed as a guest-host liquid crystal including a cyan, magenta or yellow dye. The lower liquid crystal layer is disposed on the upper liquid crystal layer and disposed in the first capsular structure having a cavity. In addition, the upper liquid crystal layer overlaps the lower liquid crystal layer.

When a voltage is applied to a homogeneous alignment type liquid crystal layer, a cyan, magenta or yellow dye included in the upper liquid crystal layer is aligned in a z-direction Dz perpendicular to the x-direction Dx and the y-direction Dy, and a cyan, magenta or yellow dye included in the lower liquid crystal layer is aligned in the z-direction Dz. In addition, when a voltage is not applied to a vertical alignment type liquid crystal layer, a cyan, magenta or yellow dye included in the upper liquid crystal layer is aligned in the z-direction Dz, and a cyan, magenta or yellow dye included in the lower liquid crystal layer is aligned in the z-direction Dz. Accordingly, a display device may display a white on a display panel.

According to the present exemplary embodiment, a display device may display a black or a white on a display panel without a polarizing plate. Thus, a polarizing plate may be eliminated, and the resulting display device may have a higher transmissivity.

In addition, the upper and the lower liquid crystal layers include a cyan, magenta or yellow dye. Therefore, the upper and the lower liquid crystal layers may be formed at ⅓ of a thickness of the liquid crystal layer including dyes of each of these three colors.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein. Various features of the above described and other embodiments can thus be mixed and matched in any manner, to produce further embodiments consistent with the invention.

What is claimed is:

1. A display device comprising:
a first substrate;
a color filter layer disposed on the first substrate;
a first enclosed microcavity disposed on the color filter layer;
an upper liquid crystal layer disposed in the first enclosed microcavity and comprising a dye having a complementary color with respect to a color of the color filter layer;
a second substrate facing the first substrate;
a second enclosed microcavity disposed on the second substrate; and
a lower liquid crystal layer disposed in the second enclosed microcavity and comprising a dye having a complementary color with respect to a color of the color filter layer.

2. The display device of claim 1, wherein the color filter layer comprises:
a first color filter layer comprising a red material;
a second color filter layer disposed adjacent to the first color filter layer and comprising a green material; and
a third color filter layer disposed adjacent to the second color filter layer and comprising a blue material.

3. The display device of claim 2, wherein the upper liquid crystal layer comprises:
a first upper liquid crystal layer disposed on the first color filter layer;
a second upper liquid crystal layer disposed on the second color filter layer; and
a third upper liquid crystal layer disposed on the third color filter layer.

4. The display device of claim 3,
wherein the first upper liquid crystal layer comprises a dye having a cyan color, the second upper liquid crystal layer comprises a dye having a magenta color, and the third upper liquid crystal layer comprises a dye having a yellow color.

5. The display device of claim 3, wherein the lower liquid crystal layer comprises:
a first lower liquid crystal layer disposed on the first upper liquid crystal layer;
a second lower liquid crystal layer disposed on the second upper liquid crystal layer; and
a third lower liquid crystal layer disposed on the third upper liquid crystal layer.

6. The display device of claim 5,
wherein the first lower liquid crystal layer comprises a dye having a cyan color, the second lower liquid crystal layer comprises a dye having a magenta color, and the third lower liquid crystal layer comprises a dye having a yellow color.

7. The display device of claim 1, wherein a dye of the upper liquid crystal layer is aligned in a first direction, and a dye of the lower liquid crystal layer is aligned in a second direction crossing the first direction.

8. The display device of claim 1, wherein the upper liquid crystal layer and the lower liquid crystal layer comprise a homogeneous alignment type liquid crystal.

9. The display device of claim 1, wherein the upper liquid crystal layer and the lower liquid crystal layer comprise a vertical alignment type liquid crystal.

10. The display device of claim 1, further comprising:
a first cover part disposed on the first substrate; and
a second cover part disposed on the second substrate.

11. A method of manufacturing a display device, the method comprising:
forming a color filter layer on a first substrate;
forming a first enclosed microcavity on the color filter layer;
forming an upper liquid crystal layer in the first enclosed microcavity, the upper liquid crystal layer comprising a dye having a complementary color with respect to a color of the color filter layer;
forming a second enclosed microcavity on a second substrate facing the first substrate; and
forming a lower liquid crystal layer in the second enclosed microcavity, the lower liquid crystal layer comprising a dye having a complementary color with respect to a color of the color filter layer.

12. The method of claim 11, wherein the forming a color filter layer comprises:
forming a first color filter layer comprising a red material;
forming a second color filter layer comprising a green material; and
forming a third color filter layer comprising a blue material.

13. The method of claim 12, wherein the forming an upper liquid crystal layer comprises:
forming a first upper liquid crystal layer on the first color filter layer;
forming a second upper liquid crystal layer on the second color filter layer; and
forming a third upper liquid crystal layer on the third color filter layer.

14. The method of claim 13,
wherein the first upper liquid crystal layer comprises a dye having a cyan color, the second upper liquid crystal layer comprises a dye having a magenta color, and the third upper liquid crystal layer comprises a dye having a yellow color.

15. The method of claim 13, wherein the forming a lower liquid crystal layer comprises:
forming a first lower liquid crystal layer on an area of the second substrate corresponding to the first upper liquid crystal layer;
forming a second lower liquid crystal layer on an area of the second substrate corresponding to the second upper liquid crystal layer; and
forming a third lower liquid crystal layer on an area of the second substrate corresponding to the third upper liquid crystal layer.

16. The method of claim 15,
wherein the first lower liquid crystal layer comprises a dye having a cyan color, the second lower liquid crystal layer comprises a dye having a magenta color, and the third lower liquid crystal layer comprises a dye having a yellow color.

17. The method of claim 11, wherein a dye of the upper liquid crystal layer is aligned in a first direction.

18. The method of claim 17, wherein a dye of the lower liquid crystal layer is aligned in a second direction crossing the first direction.

19. The method of claim 11, wherein the upper liquid crystal layer and the lower liquid crystal layer comprise a homogeneous alignment type liquid crystal.

20. The method of claim 11, wherein the upper liquid crystal layer and the lower liquid crystal layer comprise a vertical alignment type liquid crystal.
